(19) United States
(12) Patent Application Publication
(10) Pub. No.: US 2024/0417939 A1
(43) Pub. Date: Dec. 19, 2024

(54) CLEANING MACHINE WITH IMPROVED CURB FOLLOW SYSTEM

(71) Applicant: RAVO B.V., Alkmaar (NL)

(72) Inventor: Rob PRINS, Alkmaar (NL)

(73) Assignee: RAVO B.V., Alkmaar (NL)

(21) Appl. No.: 18/720,472

(22) PCT Filed: Dec. 9, 2022
(86) PCT No.: PCT/NL2022/050713

§ 371 Date: Jun. 14, 2024

(30) Foreign Application Priority Data
Dec. 15, 2021 (NL) 2030143

(51) Int. Cl. E01H 1/08; A46B 13/02; G05D 1/243; G05D 1/648; G05D 1/81; G05D 101/15; G05D 105/10; G05D 107/13

(52) U.S. Cl. CPC E01H 1/0845; A46B 13/02; G05D 1/2435; G05D 1/648; G05D 1/81; A46B 2200/3066; E01H 2001/0881; G05D 2101/15; G05D 2105/10; G05D 2107/13

(57) ABSTRACT

The invention is in the field of a mobile installation for street cleaning, also referred to as a cleaning machine for a road or pavement or gutter, for removing undesirable matter from roads or like surfaces, with or without moistening of the surface. These machines are used to remove objects, such as small items, such as leaves, and debris, and dirt from a road or the like, using a broom system for cleaning the road or the like, and typically a storage for removed objects and dirt.

### FIELD OF THE INVENTION

The invention is in the field of a mobile installation for street cleaning, also referred to as a cleaning machine for a road or pavement or gutter, for removing undesirable matter from roads or like surfaces, with or without moistening of the surface. These machines are used to remove objects, such as small items, such as leaves, and debris, and dirt from a road or the like, using a broom system for cleaning the road or the like, and typically a storage for removed objects and dirt.

### BACKGROUND OF THE INVENTION

The present invention relates to a cleaning machine. A main function of such a cleaning machine is to remove dirt/debris specifically from the gutter (side of the road, edge of the pavement; curb) and to remove it from the street; dirt/debris may be understood to relate to all smaller items being present and to be up-taken. Collecting and removing the debris is typically done by means of broom(es) which sweep the debris in a direction of an uptake element, and uptake of the debris then takes place, such as by under-pressure, e.g., vacuum. FIG. 1 shows an example of a prior art cleaning machine, wherein brooms, located underneath the cleaning machine and rotating, sweep the dirt/debris towards a suction mouth. The suction mouth is provided with under-pressure, thereby up-taking the dirt/debris into the machine, though a suction tube, towards a container of the machine.

For proper up-taking of dirt/debris an operator, typically the driver of the cleaning machine, uses a broom control device to move the brooms towards the dirt and debris, and at the same time steering the cleaning machine, paying attention to traffic and pedestrians, and so on. The broom control device may be a joystick or the like. The position of the entire machine is controlled by the steering controls of the driver, such as a typical steering wheel. It is found that manually and simultaneously controlling all these movements requires a high level of practice, as well as good eye-hand coordination, and concentration. In practice, there are very few operators that are skilled enough to get optimum performance of the system. Lack of accuracy of the above-described manual process may have a large impact on quality, efficiency, and speed of the cleaning work performed. Also, from an ergonomics point of view, the above is a challenging topic to address, as it is physically demanding and technically very complex to solve.

Some documents may be referred to. For instance, DE 10 2017 117013 A1 recites a semi-autonomous following device, having at least one drive apparatus, at least one apparatus for steering the drive apparatus, at least one apparatus for detecting a guidance signal, at least one control unit which activates, as a manipulated variable, the apparatus for steering the at least one drive apparatus, as a function of the guidance signal. According to the invention there is provision that the control unit or a unit which is separate from the control unit activates further apparatuses as a function of the guidance signal, wherein the further apparatuses are selected from the group comprising: direction indicator, vehicle lights, machine modules and radio-operated remote-control systems. The interconnection of the apparatuses increases the safety of the locomotion of the following device in the public space and also the efficiency of the cooperation between the machine and the user. CN 103 161 133 A recites a an intelligent road-cleaning vehicle based on machine vision. The intelligent road-cleaning vehicle comprises a vehicle body provided with a cleaning machine, a first light source, a second light source, an image obtaining device, an image extracting device, an image processing device, a first judging device and an automatic turning device, wherein the image extracting device is used for extracting an image of a targeted area from a road surface image, the image processing device is used for conducting grayscale adjustment and binarization treatment to the image of the targeted area to generate a binary image and covering a two-dimensional array corresponding to the binary image to count the number of elements with values of one in the two-dimensional array, the first judging device is used for judging whether the number of the elements with the values of one is larger than a preset value, and the automatic turning device is used for sending an order of turning right to the vehicle body when a judging result of the first judging device is yes, and sending an order of turning left to the vehicle body when the judging result of the first judging device is no. The intelligent road-cleaning vehicle is based on the machine vision, is capable of turning and changing speed automatically, and has a value of actual popularization. CN 103 696 381 A recites a control method, a control device, a control system and a sweeping vehicle for road edge cleaning. The control method comprises the following steps: obtaining the distance between a sweeping device and a road edge in real time according to the information of the road edge; when the distance between the sweeping device and the road edge exceeds a preset range, sending out a control command so as to adjust the position of the sweeping device, so that the distance between the sweeping device and the road edge is always in the preset range so as to ensure that the sweeping of the road edge is efficiently completed, avoid collision with the road edge, reduce the working difficulty of operators and improve the work efficiency. WO 2020/144011 A1, which is published after the present priority date, recites a method for operating a cleaning vehicle, in particular a road sweeper which can be operated in an automated manner, by means of a control device, wherein a trajectory is calculated and control commands for longitudinal guidance and lateral guidance of the cleaning vehicle when driving along the calculated trajectory are generated, measurement data are received from at least one sensor for determining a cleaning area, and at least one actuator for positioning a cleaning apparatus of the cleaning vehicle for cleaning the cleaning area is controlled in the longitudinal direction and/or transverse direction relative to a direction of travel of the cleaning vehicle on the basis of the received measurement data. A control device, a computer program and a machine-readable storage medium are also disclosed. Also WO 2021/118341 A1, EP 0 291 844 A2 A, EP 0 467 269 A2, U.S. Pat. No. 5,249,332 A, and DE 43 32 287 C1 may be referred to. WO 2021/118341 A1 recites a cleaning machine for a road or pavement or gutter. These machines are used to remove objects, such as small items, such as leaves, and dirt from a road or the like, using a broom system for cleaning the road or the like, and typically a storage for removed objects and dirt. EP 0 291 844 A2 recites a street sweeper machine for picking up and transporting trash comprising a frame having a main longitudinal dimension and engaging front and rear wheels, a driver's cab, motor members, a trash bin a roll brush located between said wheels and having a symmetry axis parallel to a surface to be cleaned and transverse to said longitudinal dimension, a trash conveyor conveying trash from said roll brush to said bin, and steering members engaging all of said wheels to make all of them steerable and adapted to define an intersect point for the axes of said wheels in cornering which lies proximate a continuation of said symmetry axis of said roll brush. EP 0 467 269 A2 recites a self-propelled cleaning vehicle comprising matter removal means including primary brushes and an additional or third brush. The third brush is mounted on a brush mounting arm comprising inner and outer arm portions, pivotally interconnected, and controlled by a control linkage interconnecting them and actuated by a remote actuating ram at the inboard end of the assembly. When the third brush is in use, contour-following means enables the inboard primary brush to follow the peripheral contours of a surface it is sweeping without driver intervention. Such automatic contour-following is activated by driver-controlled selection of a contour-following control mode which causes the inboard brush to move outwards until it meets, for example, a gutter profile. Position sensing switches enable the primary brushes to automatically adopt standard sweeping positions when a non-contour following mode is selected. U.S. Pat. No. 5,249,332 A recites an apparatus for automated sweeping of debris from pavement surfaces with a rigid housing, paired roller brooms rotatably mounted transversely within the housing parallel in relation to each other such that the right end of the forward roller broom, as from the position of an operator of the apparatus, rotates clockwise and the right end of the rearward roller broom, from the same viewpoint, operates counter-clockwise. DE 43 32 287 C1 recites a method and a device for guiding a motor vehicle, preferably in tight traffic areas, the invention being based on the object of making it possible to use commercial vehicles, primarily of larger sizes, particularly in small, constricted traffic areas and on confusing traffic routes at risk from accidents, the intention being in particular for supply and disposal procedures of vehicles with a high payload to be carried out with precise steering and guiding manoeuvres which can be matched to the traffic conditions present in a manner protected against accidents and without risk. Although modern vehicles can largely follow a side of the road when cleaning, or likewise follow a pavement or gutter or curb or the like, there is still room for improvement.

The present invention therefore relates to an improved cleaning machine, which overcome one or more of the above disadvantages, without jeopardizing functionality and advantages.

### SUMMARY OF THE INVENTION

The present invention relates in a first aspect to a cleaning machine (1) for a road or pavement or gutter comprising a vehicle (2), the vehicle comprising at least one with respect to the vehicle vertically and horizontally movable broom system (3), at least one front wheel (21), in particular two front wheels (21), and at least one rear wheel (22), in particular two rear wheels (22), wherein the vehicle comprises at least one seat for an operator, at least one controller (4) for moving said broom system, a pavement track system (6) comprising a 3D camera (7) providing 3D-images, pattern recognition software adapted to process the 3D-images, wherein the pattern recognition software identifies a side of the road, and wherein the pattern recognition software measures a distance from the vehicle to the side of the road, and wherein the at least one controller is adapted to move the broom-system sideways with respect to the vehicle such that a distance between the broom system and side of the road is controlled, characterized in that the at least one rear wheel (22) is configured to rotate along a vertical axis over a rear wheel vertical angle of 1-50 degrees, in particular 2-30 degrees, such as 3-15 degrees, and wherein at least one controller is adapted to switch from a sweeping mode to a transport mode, and vice versa, and when in sweeping mode is adapted to switch from a free sweeping mode to a curb-follow-sweeping mode, and vice versa. Therewith the cleaning machine is better controlled, is capable of following curves, curbs, gutter, and sides of a road more accurate, and is capable of removing dirt, dust, and the like more effectively. In particular, when the cleaning machine is close to a side of the road, such as a curb, and the cleaning machine is steered away from the side of the road, the present cleaning machine does not hit the side of the road with a rear part thereof. This is effected by switching between a free sweeping mode, wherein in this respect no restrictions to the position of the at least one rear wheel are provided, to a curb-follow-sweeping mode, wherein the rotation of the at least one rear wheel is controlled, and typically limited to a position substantially parallel to the side of the road, such that the distance of the rear part of the machine and at least one rear wheel to the side of the road is maintained substantially constant. As such the rear side of the machine or for that matter the at least one rear wheel can not hit the side of the road. This situation occurs in particular when the cleaning machine is close to a side of the road and is steered away therefrom, or when the road makes a bent and the cleaning machine needs to follow that bent. The at least one vertically and horizontally movable broom system is typically provided on a right side of the cleaning machine in countries where vehicles drive at a right side of the road, or in the alternative on the left side. A second broom may typically be provided at the other (left or right) side. So, each broom system may comprise one broom, two brooms, or more than two brooms, such as three brooms. Therewith significant improvements are achieved. By implementing a 3D camera, image recognition and connecting it to the described machine control functions, the above-described functions are automated during a significant part of the operating/cleaning process. A reliable, automated broom positioning system is found to have a positive effect on quality, efficiency, speed, and ergonomic aspects of the work performed. A reliable recognition of the curb is provided, by ignoring the dirt (to be removed) visible in the image, compensating for broom-wear, and adapting for difficult image situations (high contrast, low light, etc.). Added value of the system is found in a lower strain, stress, and fatigue for the operator during significant part of the operation, both physical (ergonomics, repetitive movements, sitting position) and psychological (concentration, fatigue), a better and more constant quality of work, i.e. better and more efficient cleaning, and no declining of quality by loss of concentration or distraction of the operator. Further it is found that past experience of the operator has less or no influence on the quality of the work. In addition, an improved traffic security is provided, as the operator can pay more attention to traffic, pedestrians and other surroundings. Typical components of the present pavement track system are a 3D camera, image recognition software+hardware, including a connection to machine control functions. The image recognition software used may be Open Source software. The software is taught to detect the curb. Electronic control of at least one broom side-shift is provided, as well as electronic control of vehicle steering (including manual override safety). Some main software steps may be acquisition of a 3D image from the camera, a translation of the 3D-image to a 2D image, a determination of a “rising edge” or “falling edge” in the 2D image, representing the curb, identifying at least 3 points on the “rising edge”/“falling edge” and thereby validating a line representing the curb on reliability, such as by calculation a standard deviation, establishing if these at least 3 points are reliable for at least 2 consecutive frames/images and then accepting the representation of the curb, and further, when accepted, these points are sent to a machine control such as via CAN, to initiate the required control actions. It is found that the identification of the falling edge, i.e. an upper edge of a curb, provides more reliable and reproduceable results. The edge is preferably determined ahead of the machine, in the direction of movement, such as 0.5-3 m ahead of the machine, e.g. 1-2 m. As the speed of the cleaning machine is known, the speed of the machine, and the measured distance of the broom from a curb, can be used to move the brush-system towards or from the curb when advancing. Typically positioning of the can be done by moving the broom-system and/or vehicle sideways such that a distance between the broom system and side of the road is controlled. The vehicle control can at least partly by overtaken by an automated system, in view of the present hydraulic system, such as an orbitrol. The automated system can perform relatively simple tasks, such as positioning of the cleaning machine, driving, steering, and somewhat more complex tasks, as recognition of obstacles and human beings, especially in front of the machine. In view of the limited speed of the cleaning machine such an automated system could already be sufficient.

For improved range and added functionality, an option is to use the third broom system. This option provides an increased sweeping width/range and is often used with a dedicated broom for weed removal. Operating this third broom typically has similar requirements as the first and second brooms: it may be too far from the curb and thereby dirt/debris is missed/not picked up, it may be too close to the curb and the wires of the broom are pushed flat, the broom does not move the dirt effectively. Operation of the third broom may be done by a second joystick, in addition to the standard controls. For the operator this implies operating two joysticks simultaneously; operating/movement of this 3rd broom is very frequent. The construction of the third broom is typically similar to the first and second broom system: the position of the third broom relative to the machine, controlled by the so-called “third broom side-shift”, this is a linear movement, perpendicular to the length axis of the machine (driving direction). And the distance between the machine itself and the curb is controlled. In a second aspect the present invention relates to a pavement track system computer program comprising instructions for operating the cleaning machine (1) according to the invention, the instructions causing the computer (1) to carry out the following steps: loading 3D images, identifying the pavement; determining a distance between the broom system and pavement; and maintaining said distance within predetermined limits by moving said broom system by means of the controller sideways and by rotating the at least one rear wheel (22) along a vertical axis over a rear wheel vertical angle of 1-50 degrees, in particular 2-30 degrees, characterized in based on the distance of the cleaning machine to the side of the road and configuration of said side of the road causing the at least one controller to switch from a sweeping mode to a transport mode, and vice versa, and when in sweeping mode is adapted to switch from a free sweeping mode to a curb-follow-sweeping mode, and vice versa, wherein, in the sweeping mode, the rotation of the at least one rear wheel is controlled, and typically limited to a position substantially parallel to the side of the road, such that the distance of the rear part of the machine and at least one rear wheel to the side of the road is maintained substantially constant.

Thereby the present invention provides a solution to one or more of the above-mentioned problems.

Advantages of the present invention are detailed throughout the description.

### DETAILED DESCRIPTION OF THE INVENTION

The present invention relates in a first aspect to a cleaning machine according to claim 1.

In an exemplary embodiment of the present cleaning machine the at least one controller is adapted to rotate the at least one rear wheel (22) by switching from the free sweep mode to the curb-follow-sweep mode, in particular in view of the side of the road, more in particular such that the distance from the vehicle to the side of the road is kept constant and larger than 0 cm by said at least one controller, in particular until the at least one front wheel exceeds a predetermined angle. The controller is capable of keeping the distance constant within 5 cm, and typically within 3 cm. Such is considered sufficient to obtain improved operation of the broom system, in particular of uptaking debris and the like. Typically the angle of the at least one rear wheel is initially maintained substantially parallel to the side of the road. Once the at least one front wheel exceed a certain angle, such as 40 degrees, and the vehicle is far enough away from the side of the road, the angle of the at least one rear wheel can follow the angle of the at least one front wheel; the controller can switch towards free sweep mode. One might consider this as an override of the pavement track system control.

In an exemplary embodiment of the present cleaning machine the at least one front wheel (21), in particular two front wheels (21), are adapted to rotate along a front wheel vertical axis, wherein the at least one rear wheel is configured to rotate over a rear wheel vertical angle which is opposite to a rotation of the front wheel vertical angle.

In an exemplary embodiment of the present cleaning machine in free sweeping mode the at least one rear wheel (22) is configured to rotate over a rear wheel vertical angle with an angle size which is 0.5-2.0 times the size of the rotation front wheel angle, in particular 0.7-1.3 times the size of the rotation front wheel angle, more in particular 0.9-1.1 times the size of the rotation front wheel angle, or wherein in curb-follow-sweep mode the at least one rear wheel (22) is configured to rotate over a rear wheel vertical angle such that the at least one rear wheel is maintained substantially parallel to a side of the road, in particular until the at least one front wheel exceeds a predetermined angle. By coupling the rotation of the front wheel(s) and rear wheel(s) it is found that a better control of the movement and position of the cleaning machine is obtained. As a consequence also the cleaning efficiency is improved.

In an exemplary embodiment of the present cleaning machine the at least one controller is configured to rotate the at least one rear wheel (22) over the rear wheel vertical angle, which rear wheel vertical angle is further controlled in view of speed of the cleaning machine (1), in particular wherein the rear wheel vertical angle is controlled to rotate over the rear wheel vertical angle over angle which inversely decreases with speed of the vehicle, such as decreases according to rotation angle˜1/(speed [m/s]. For instance, when a maximum rotation angle is 50 degrees and a minimum 0 or 1 degrees, the rotation angle may vary according to angle=C+E*(maxᵣₒₜ−minᵣₒₜ)/speed, e.g. @0.5 m/s 28.2 degrees, @1.5 m/s 10.1 degrees, @2.5 m/s 6.4 degrees, etc. Above a certain speed, in addition, the angle may be limited to a constant value, e.g. above 6 m/s the angle may be constant at 3.2 degrees.

In an exemplary embodiment of the present cleaning machine at least one controller is configured to be switched of in order to not rotate the at least one rear wheel (22) over the rear wheel vertical angle, such as when the vehicle is in transport mode, or likewise when the vehicle is in rest, or just driving.

In an exemplary embodiment of the present cleaning machine the controller is adapted to move the vehicle sideways such that a distance between the broom system and side of the road is controlled. Such is found to provide optimal sweeping.

In an exemplary embodiment of the present cleaning machine the controller adapts the distance in view of broom wear, such as by increasing or decreasing a distance, typically a distance determined by the controller.

In an exemplary embodiment the present cleaning machine further comprises a second broom system, and optionally a third broom system. A second broom system is preferred, especially in view of up taking debris and the like. A third broom system is found to contribute even further in that respect, especially in view of more heavy debris and the like.

In an exemplary embodiment of the present cleaning machine the software adapts for contrast and/or wherein the software adapts for shadow effects. It is found difficult in change light conditions, and changing seasons, to use the same software for detecting debris and the like, and for detecting road elements, such as curbs. Adapting for shadow and/or contrast improves the reliability of the present cleaning machine.

In an exemplary embodiment of the present cleaning machine the software is trained for recognizing the pavement, such as for identifying a rising edge thereof (curb). Often the pavement is used for steering and the like.

In an exemplary embodiment the present cleaning machine is adapted to be steered by an operator or driver. In addition to the present at least one controller typically a driver may be present. The driver can assist in steering, or likewise, the controller can assist the driver, or a combination thereof.

In an exemplary embodiment of the present cleaning machine the software is adapted to validate a position of the rising edge, such as by validating if at least three identified points of the rising edge have a linear relationship (are on one line), and/or wherein the rising edged is validated on at least two consecutive 3D-images, and combinations thereof.

In an exemplary embodiment of the present cleaning machine the control is electronic, and/or wherein a CAN-bus is used for control.

In an exemplary embodiment of the present cleaning machine the controller is adapted to be manually over-ride. Such may be required, as in emergency situations, or by government regulations.

In an exemplary embodiment of the present cleaning machine the controller is adapted to maintain the distance between the broom system and side of the road at a constant value within a predetermined limit, such as with an accuracy of better than ±5 cm, typically better than ±3 cm. The exact speed of the cleaning machine itself is found to be an important noise factor in this respect.

In an exemplary embodiment of the present cleaning machine an orientation of the 3D-camera is adaptable, such as adaptable to be oriented substantially towards a side of the road, and/or adaptable to be in a height position providing images of the side of the road.

In an exemplary embodiment of the present cleaning machine brooms are adapted to sweep debris and dirt to a suction point, such as by rotating.

In an exemplary embodiment of the present cleaning machine brooms are adapted to move with respect to the cleaning-machine in a horizontal direction and/or vertical direction, preferably move each individually, and preferably move independent in the horizontal and vertical direction.

In an exemplary embodiment of the present cleaning machine the cleaning machine comprises a suction system for up-taking debris and dirt from the suction point, such as an enlarged suction opening, connected to the suction opening a suction tube, at the other end of the suction tube a container for receiving dirt and debris, and a fan for providing suction, such as by under-pressure.

In an exemplary embodiment of the present cleaning machine the cleaning machine comprises at least one ventilation opening, and an outlet, preferably comprising a filter for removing small particles.

In an exemplary embodiment of the present cleaning machine further comprises a display (5), such as for showing parameters of the cleaning machine, such as speed, suction power, images of the 3D camera, etc.

In an exemplary embodiment the present pavement track system computer program further comprises instructions for recognition of a curb, and/or neglecting the dirt/debris to be removed visible in the image, and/or compensating for broom-wear, and/or adapting for difficult image situations, such as high contrast, and low light.

The invention is further detailed by the accompanying figures and examples, which are exemplary and explanatory of nature and are not limiting the scope of the invention. To the person skilled in the art it may be clear that many variants, being obvious or not, may be conceivable falling within the scope of protection, defined by the present claims.

### SUMMARY OF THE FIGURES

FIG. 1 show an exemplary embodiment of the present machine.

FIGS. 2a-b show a third broom system.

FIGS. 3a-d show operational aspects of the present cleaning machine.

FIGS. 4a-b show prior art steering modus.

FIGS. 5a-c show steering modus of the present cleaning machine.

### DETAILED DESCRIPTION OF THE FIGURES

In the figures:
1 Cleaning machine
2a first right hand broom
2b optional second left hand broom
2c optional third broom
3 suction mouth
4 suction tube
5 container
6 filter
7 outlet
8 suction fan
9 side shift
10 3D camera

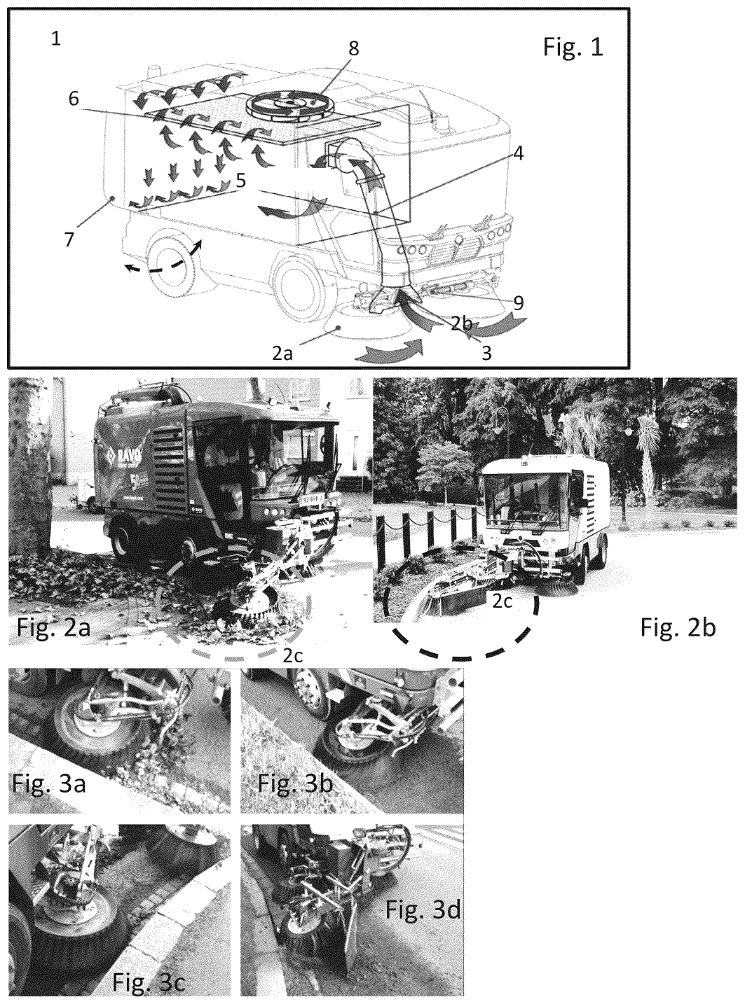

FIG. 1 show an exemplary embodiment of the present machine.

FIGS. 2a-b show a third broom system, indicated with a circle.

The figures are further detailed in the description and examples below.

The present cleaning machine takes over a significant part of the manual control of several functions of the sweeper, during sweeping operation. This reliefs the driver of a difficult, tiring task.

In an example the present modification is designed and integrated in the sweeper, leaving all existing/present functions of e.g. the Ravo type 5 machine otherwise unchanged. Controlling these functions can still be performed manually, but also an automatic mode is available.

The present sweeper, or streetsweeper, can best be described as a large domestic vacuum cleaner. All typical components of a vacuum cleaner are typically there: an engine driving a (centrifugal) fan that creates vacuum, thus creating air movement in a suction nozzle that picks up dirt/debris. Through a (suction) tube the airflow transports the dirt/debris into the dirt/debris container (See FIG. 1). To be able to work on a road surface, the machine typically meets a number of road-specific requirements: (i) it provides sufficient cleaning width: as the width of the suction nozzle is typically only 30 cm, this is too narrow to deliver efficient cleaning. To increase the cleaned surface width, brooms are added, that move dirt/debris from both sides (L+R) to the center of the machine, where the suction nozzle is located (See FIG. 1); (ii) as a standard two brooms (L+R) are typically provided, which result in a total sweeping width of approximately 2 meters; (iii) an optional third 3rd broom is provided for an increased width with approximately 70-90 cm extra. It also provides an increased flexibility to reach into corners and other hard to reach areas. (iv) As the brooms typically use a certain force on the ground, that is kept more or less constant, independent from shape of the road-surface, speed-bumps and broom wear (a worn broom weighs less than a new one)

This load-regulating system is based on a spring-loaded mechanism; (v) The brooms are best kept in a rather precise position relative to the side of the road and/or curb to function properly; when they are too far from the curb dirt/debris may be missed, when they are too close to the curb hairs/wires from the broom may be pushed flat to the surface, and the broom may not work properly. This relative position is typically determined by two factors: The position of the entire machine; this may be controlled by the driver/operator, steering the machine towards—or away from the curb (normal/standard steering function of the vehicle); The position of the 2 standard brooms, relative to the machine; to provide easy, fast position changing of the brooms, vertically and horizontally movable broom system onto which these brooms are preferably mounted on a sub-frame (“broom carriage”) that can move sideways (perpendicular to the driving direction of the vehicle); this system is called “side-shift” and enables the brooms to be positioned closer or further away to the curb. This side-shift, and the relative position of the broom with respect to the machine is controlled with a sensor, the sensor measuring the relative position and capable of adapting the relative position. This movement is controlled by hand, with a controller, by the operator. Electrical signals from the joystick (part of the controller) are connected to the computer controlling the machine (PLC); this PLC in its turn sends electrical signals to the hydraulic valves (operator, joystick). The physical movement of the entire broom carriage is typically powered by a hydraulic cylinder (See FIG. 1); (vi) The principle of operating the 3rd broom is identical to that of the standard brooms, but it is mounted on a separate frame and thus able to function independent from the standard brooms (See FIGS. 2a and 2b).

The above describes functionality of the present sweeper, relating to proven Ravo 5 technology.

The integration of the present invention into the Ravo 5 machine may be done mainly electrically, such as through software, or by adding an electrical function to an existing (hydraulic) component. An example of the latter is an additional, electrically controlled steering function. This allows the electronic machine control to influence the mechanical/hydraulic steering unit, thus creating automated steering.

Addition of the 3D camera to the machine, creating a 3D image to determine the distance between the machine and the curb, by image recognition, and bring this information with respect to the distance to the control-computer of the machine, allows the introduction of an automatic sweep function, relieving the driver of a tiring task, creating better efficiency, and more safety.

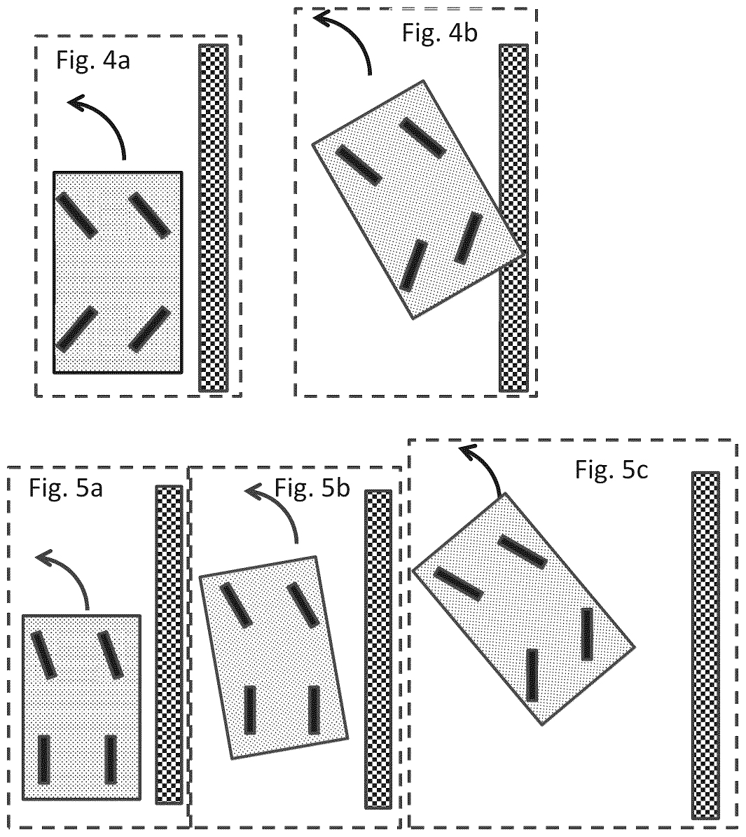

FIGS. 4a-b show prior art steering modus. Therein the rear wheels follow the angle of the front wheels, typically in opposite direction. The prior art cleaning vehicle will when steered leftwards (counter clockwise) (FIG. 4a) and moving upwards hit the side of the road as a consequence (FIG. 4b), in particular with a rear side of the cleaning machine.

FIGS. 5a-c show steering modus of the present cleaning machine. The present cleaning machine recognizes its relative position in respect of the side of the road, in particular a curb thereof. The present cleaning vehicle will when steered leftwards (counter clockwise) (FIG. 5a) and moving upwards, maintain the rotation of the rear wheels substantially parallel to the side of the road, gradually moving away from the side of the road (FIGS. 5b and 5c), and only when it is far enough away of the side of the road start to rotate the rear wheels (again). The oration of the rear wheels is so to say over-ride in this curb-follow-sweep mode. Therewith the present vehicle does not hit the side of the road as a consequence, in particular with a rear side of the cleaning machine.

1. Cleaning machine for at least one selected of a road and pavement, and a gutter comprising
a vehicle, the vehicle comprising at least one with respect to the vehicle vertically and horizontally movable broom system, at least one front wheel, and at least one rear wheel, wherein the vehicle comprises at least one seat for an operator,
at least one controller for moving said broom system,
a pavement track system comprising a 3D camera providing 3D-images, pattern recognition software adapted to process the 3D-images, wherein the pattern recognition software identifies a side of the road, and wherein the pattern recognition software measures a distance from the vehicle to the side of the road, and
wherein the at least one controller is adapted to move the broom-system sideways with respect to the vehicle such that a distance between the broom system and side of the road is controlled,
characterized in that
the at least one rear wheel is configured to rotate along a vertical axis over a rear wheel vertical angle of 1-50 degrees, and
wherein at least one controller is adapted to switch from a sweeping mode to a transport mode, and vice versa, and when in sweeping mode is adapted to switch from a free sweeping mode to a curb-follow-sweeping mode, and vice versa, wherein, in the sweeping mode, the rotation of the at least one rear wheel is controlled, and typically limited to a position substantially parallel to the side of the road, such that the distance of the rear part of the machine and at least one rear wheel to the side of the road is maintained substantially constant.

2. The cleaning machine according to claim 1, wherein the at least one controller is adapted to rotate the at least one rear wheel by switching from the free sweep mode to the curb-follow-sweep mode.

3. The cleaning machine according to claim 1, wherein the at least one front wheel, are adapted to rotate along a front wheel vertical axis, wherein the at least one rear wheel is configured to rotate over a rear wheel vertical angle which is opposite to a rotation of the front wheel vertical angle.

4. The cleaning machine according to claim 1, wherein at least one is selected of
in free sweeping mode the at least one rear wheel is configured to rotate over a rear wheel vertical angle with an angle size which is 0.5-2.0 times the size of the rotation front wheel angle, and
wherein in curb-follow-sweep mode the at least one rear wheel is configured to rotate over a rear wheel vertical angle such that the at least one rear wheel is maintained substantially parallel to a side of the road.

5. The cleaning machine according to claim 1, wherein at least one controller is configured to rotate the at least one rear wheel over the rear wheel vertical angle, which rear wheel vertical angle is further controlled in view of speed of the cleaning machine.

6. The cleaning machine according to claim 1, wherein at least one controller is configured to be switched of in order to not rotate the at least one rear wheel over the rear wheel vertical angle.

7. The cleaning machine according to claim 1, wherein the controller is adapted to move the vehicle sideways such that a distance between the broom system and side of the road is controlled.

8. The cleaning machine according to claim 1, wherein the controller adapts the distance in view of broom wear.

9. The cleaning machine according to claim 1, further comprising a second broom system.

10. The cleaning machine according to claim 1,
wherein the software adapts for contrast and/or wherein the software adapts for shadow effects, and
wherein the software is trained for recognizing the pavement.

11. The cleaning machine according to claim 1, adapted to be steered by an operator or driver.

12. The cleaning machine according to claim 11, wherein the software is adapted to validate a position of the rising edge, and wherein the rising edge is validated on at least two consecutive 3D-images, and combinations thereof.

13. The cleaning machine according to claim 1, wherein the control is electronic, and wherein a CAN-bus is used for control.

14. The cleaning machine according to claim 1, wherein the controller is adapted to be manually over-ride.

15. The cleaning machine according to claim 1, wherein the controller is adapted to maintain the distance between the broom system and side of the road at a constant value within a predetermined limit.

16. The cleaning machine according to claim 1, wherein an orientation of the 3D-camera is adaptable, and adaptable to be in a height position providing images of the side of the road.

17. The cleaning machine according to claim 1, wherein brooms are adapted to sweep debris and dirt to a suction point, and
wherein brooms are adapted to move with respect to the cleaning-machine in at least one of a horizontal direction and a vertical direction, and preferably move independent in the horizontal and vertical direction, and
wherein the cleaning machine comprises a suction system for up-taking debris and dirt from the suction point, connected to the suction opening a suction tube, at the other end of the suction tube a container for receiving dirt and debris, and a fan for providing suction, and
wherein the cleaning machine comprises at least one ventilation opening, and an outlet,
and
further comprising a display.

18. A pavement track system computer program, when loaded and executed on a computer, comprising instructions for operating the cleaning machine according to one of the claim 1, the instructions causing the computer to carry out the following steps:
loading 3D images,
identifying the pavement;
determining a distance between the broom system and pavement; and
maintaining said distance within predetermined limits by moving said broom system by means of the controller sideways and by rotating the at least one rear wheel along a vertical axis over a rear wheel vertical angle of 1-50 degrees, characterized in
based on the distance of the cleaning machine to the side of the road and configuration of said side of the road causing the at least one controller to switch from a sweeping mode to a transport mode, and vice versa, and when in sweeping mode to switch from a free sweeping mode to a curb-follow-sweeping mode, and vice versa, wherein, in the sweeping mode, the rotation of the at least one rear wheel is controlled, and typically limited to a position substantially parallel to the side of the road, such that the distance of the rear part of the machine and at least one rear wheel to the side of the road is maintained substantially constant.

19. The pavement track system computer program according to claim 18, further comprising instructions for
recognition of a curb, and
neglecting the dirt/debris to be removed visible in the image, and
compensating for broom-wear, and
adapting for difficult image situations.
